(19) United States
(12) Patent Application Publication
(10) Pub. No.: US 2022/0276773 A1
(43) Pub. Date: Sep. 1, 2022

(54) VIDEO DISPLAY METHOD FOR SLICING SCREEN, VIDEO DISPLAY DEVICE, COMPUTER APPARATUS, AND MEDIUM

(71) Applicant: BOE Technology Group Co., Ltd., Beijing (CN)

(72) Inventors: Shuyi LI, Beijing (CN); Guangyu SHAO, Beijing (CN); Wenjuan LI, Beijing (CN); Peng LI, Beijing (CN); Yang QIN, Beijing (CN); Xiaoyang WANG, Beijing (CN); Hong WANG, Beijing (CN)

(21) Appl. No.: 17/631,485

(22) PCT Filed: Mar. 26, 2021
(86) PCT No.: PCT/CN2021/083199

§ 371 Date: Jan. 30, 2022

(30) Foreign Application Priority Data
Apr. 29, 2020 (CN) 202010357266.7

(51) Int. Cl. G06F 3/04847; H04N 5/268

(52) U.S. Cl. CPC G06F 3/04847; H04N 5/268

(57) ABSTRACT

The present disclosure provides a multi-screen video display method, a video display device, a computer apparatus, and a medium. The video display method includes: selecting in response to a first operation and a second operation of a user, a start point and an end point in a multi-screen control icon of a graphical user interface, and showing a sub-layout according to the start point and the end point, wherein the multi-screen control icon comprises multiple sub-icons, the sub-icons are objects respectively mapping sub-screens in the multi-screen display to the graphical user interface, and the sub-layout comprises all covered sub-icons from the start point to the end point; determining the sub-layout in response to a third operation of the user; and generating a video display template in response to a fourth operation of the user, and showing a video display on the graphical user interface.

### CROSS REFERENCE TO RELATED APPLICATIONS

The present disclosure claims priority to the Chinese Patent Application No. 202010357266.7, filed to the China Patent Office on Apr. 29, 2020 and entitled “MULTI-SCREEN VIDEO DISPLAY METHOD, DISPLAY DEVICE, COMPUTER APPARATUS, AND MEDIUM”, the entire contents of which are incorporated herein by reference.

### FIELD

The present disclosure relates to the technical field of display, in particular to a video display method and video display apparatus of a splicing screen, a computer device and a medium.

### BACKGROUND

A splicing screen is widely popular at home and abroad because of its excellent performance and reasonable price, which has a service life of up to 50-100 thousand of hours, and is stable in quality and low in maintenance cost, thereby becoming a curtain wall with the best price performance at present. The splicing screen occurs to solve various defects of a traditional TV curtain wall and provides a best large-screen display system for conveniently and comprehensively displaying all system video information in real time, especially engineering applications of remote real-time commanding, scheduling, etc.

### SUMMARY

A first embodiment of the present disclosure provides a video display method of a splicing screen, including:

selecting a start point and an end point in a splicing screen icon of a graphical user interface respectively in response to a first operation and a second operation of a user, and presenting a sub-layout according to the start point and the end point, wherein the splicing screen icon includes a plurality of sub-icons, each of the sub-icons is an object respectively mapping a sub-screen in the splicing screen onto the graphical user interface, and the sub-layout includes all sub-icons covered from the start point to the end point;

determining the sub-layout in response to a third operation of the user; and

generating a video display template in response to a fourth operation of the user and presenting a video display on the graphical user interface.

In some embodiments, the video display method further includes:

in response to a fifth operation of the user, selecting a to-be-displayed display material and loading it onto the splicing screen according to the video display template.

In some embodiments, the selecting the start point and the end point in the splicing screen icon of the graphical user interface respectively in response to the first operation and the second operation of the user, and presenting the sub-layout according to the start point and the end point, includes:

combining the sub-icons in the sub-layout to form a sub-layout icon and presenting the sub-layout icon in a single color.

In some embodiments, after determining the sub-layout in response to the third operation of the user, the method further includes:

performing sub-layout configuration on the sub-icons in the splicing screen icon.

In some embodiments, different sub-layouts form different sub-layout icons, and the sub-layout icons are presented in different colors.

In some embodiments, a sub-icon to which the start point corresponds and a sub-icon to which the end point corresponds form a rectangular region.

In some embodiments, the rectangular region includes:

in response to a sub-icon to which the start point corresponds and a sub-icon to which the end point corresponds being located in a row of the splicing screen icon, the sub-layout includes the sub-icons from the start point to the end point in the row;

in response to a sub-icon to which the start point corresponds and a sub-icon to which the end point corresponds being located in a column of the splicing screen icon, the sub-layout includes the sub-icons from the start point to the end point in the column; and

in response to a sub-icon to which the start point corresponds and a sub-icon to which the end point corresponds being located in different rows and different columns of the splicing screen icon respectively, the sub-layout includes the sub-icons in a rectangle with a diagonal line being from the sub-icon to which the start point corresponds to the sub-icon to which the end point corresponds.

In some embodiments, after selecting the start point and the end point in the splicing screen icon of the graphical user interface respectively in response to the first operation and the second operation of the user, and presenting the sub-layout according to the start point and the end point, and before determining the sub-layout in response to the third operation of the user, the method further includes:

continuing to select sub-icons beyond the sub-layout in response to the first operation of the user; and

selecting the start point and the end point in the splicing screen icon of the graphical user interface respectively in response to the first operation and the second operation of the user so as to continue to select the sub-icons beyond the sub-layout.

In some embodiments, the video display method further includes:

in response to a sixth operation of the user, selecting a sub-icon in the sub-layout so as to cancel configuration of the sub-icon in the sub-layout.

In some embodiments, the video display method further includes:

in response to a seventh operation of the user, loading a preset image material onto the graphical user interface and generating a display material, wherein the image material includes at least one element arranged in a cascading mode, and the element is one of a video, a picture or a text.

In some embodiments, after loading the preset image material onto the graphical user interface and generating the display material, the method further includes:

in response to an eighth operation of the user, loading a cascading style sheet onto the graphical user interface to perform a motional configuration on each element of the image material respectively so as to generate the display material.

In some embodiments, the motional configuration includes at least one of a displacement operation, a rotation operation, a scaling operation or a color configuration operation for each element respectively.

A second embodiment of the present disclosure provides a video display apparatus of a splicing screen based on a graphical user interface, including:

a template layout unit configured to configure a splicing screen icon displayed on the graphical user interface to be a sub-layout including a start point and an end point, wherein the splicing screen icon includes a plurality of sub-icons, each of the sub-icons is an object respectively mapping a sub-screen in the splicing screen onto the graphical user interface, and the sub-layout comprises all sub-icons covered from the start point to the end point; and

a display unit configured to present a video display on the graphical user interface.

A third embodiment of the present disclosure provides a computer readable storage medium with a computer program stored thereon. In response to the program being executed by a processor, the method according to the first embodiment is implemented.

A fourth embodiment of the present disclosure provides a computer device, including a memory, a processor and a computer program stored on the memory and capable of running on the processor, the processor is configured to execute the program to implement the method according to the first embodiment.

### BRIEF DESCRIPTION OF THE DRAWINGS

FIG. 1 shows a flowchart of a video display method provided by an embodiment of the present disclosure.

FIG. 2A to FIG. 2B respectively show schematic diagrams of a graphical user interface provided by an embodiment of the present disclosure.

FIG. 3A to FIG. 3C respectively show schematic diagrams of a graphical user interface provided by another embodiment of the present disclosure.

FIG. 4A to FIG. 4B respectively show schematic diagrams of a graphical user interface provided by yet another embodiment of the present disclosure.

FIG. 5A to FIG. 5B respectively show schematic diagrams before and after editing an image material provided by an embodiment of the present disclosure.

FIG. 6 shows a structural block diagram of a video display apparatus provided by an embodiment of the present disclosure.

FIG. 7 shows a schematic structural diagram of a computer device provided by another embodiment of the present disclosure.

### DETAILED DESCRIPTION OF THE EMBODIMENTS

In the related art, sub-screens of each splicing screen are arranged in sequence in general, however, there is a problem of low efficiency of sequentially arranging sub-layouts of a screen in a case of many sub-screens. As for a large screen or a splicing screen, especially in industries of catering services, movie theaters, etc. a merchant wishes that it would be convenient and fast to arrange and operate and easy to update. Therefore, how to set a video display of a splicing screen becomes a problem to be solved by a manufacturer.

In order to set forth the present disclosure more clearly, the present disclosure is further described below with reference to preferred embodiments and accompanying drawings. Similar components in the drawings are represented by the same reference numbers of the drawings. Those skilled in the art should understand that the contents detailed below are explanatory but not restrictive and are not supposed to limit the protection scope of the present disclosure.

As shown in FIG. 1, an embodiment of the present disclosure provides a video display method of a splicing screen, including:

S101, a start point and an end point are selected in a splicing screen icon of a graphical user interface respectively in response to a first operation and a second operation of a user, and a sub-layout is presented according to the start point and the end point, wherein the splicing screen icon includes a plurality of sub-icons, each of the sub-icons is an object respectively mapping a sub-screen in the splicing screen onto the graphical user interface, and the sub-layout includes all sub-icons covered from the start point to the end point;

S102, a sub-layout is determined in response to a third operation of the user;

then, whether there are the sub-icons not configured in the sub-layout in the splicing screen icon can be judged, and if yes, it returns to step S101 and selection of the start point and the end point is repeated so as to configure the sub-layout till layout configuration of all the sub-icons in the splicing screen icon is completed; and

S103, a video display template of the splicing screen is generated in response to a fourth operation of the user, and a video display is presented on the graphical user interface according to the video display template.

In some embodiments of the present disclosure, each sub-screen of the splicing screen is mapped into the sub-icons on the graphical user interface, layout setting of each sub-screen of the splicing screen is realized through an operation on the graphical user interface, thus a convenient and fast operation of the layout setting of the splicing screen is realized, a display setting effect of each sub-screen of the splicing screen is effectively improved, and application prospects are wide.

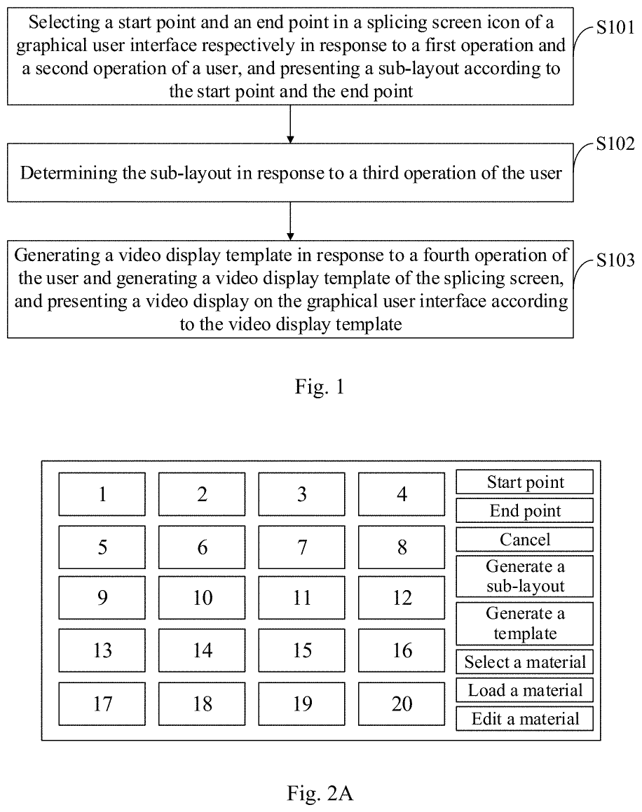

In some embodiments, as shown in FIG. 2A, description is made by taking a splicing screen including 5×4 sub-screens for example, each of the sub-screens corresponds to a sub-icon on the graphical user interface, for example, the first sub-screen corresponds to the sub-icon 1 at an upper left corner on the graphical user interface, and a twentieth sub-screen corresponds to the sub-icon 20 at a lower right corner on the graphical user interface. It should be noted that the present disclosure does not make a limit on the quantity and an arrangement mode of the sub-screens of the splicing screen, and each splicing screen can be directly mapped onto the graphical user interface according to the quantity and the arrangement mode of its contained sub-screens so as to facilitate layout setting.

In some embodiments, the video display method of the splicing screen may be operated according to the following steps.

Firstly, the sub-layout of the splicing screen is set on the graphical user interface.

The sub-icon clicked in response to selecting “start point” by the user is set to be the start point of the current sub-layout, the sub-icon clicked in response to selecting “end point” by the user is set to be the end point of the current sub-layout, the sub-icon to which the start point corresponds and the sub-icon to which the end point corresponds form the current sub-layout, and setting of the current sub-layout is completed in response to selecting “generating a sub-layout” by the user.

In some embodiments, the sub-layout in a rectangular shape may be formed by selecting the sub-icon to which the start point corresponds and the sub-icon to which the end point corresponds, which includes followings.

For example, the start point corresponds to the sub-icon 1, the end point corresponds to the sub-icon 3, that is, the sub-icon to which the start point corresponds and the sub-icon to which the end point corresponds are located in a row of the splicing screen icon, so the sub-layout includes all the sub-icons from the sub-icon 1 to the sub-icon 3 in the row, namely including the sub-icon 1, the sub-icon 2 and the sub-icon 3, and meanwhile, the selected sub-icons 1 to 3 are presented to be in a selected state.

For another example, the start point corresponds to the sub-icon 1, the end point corresponds to the sub-icon 13, that is, the sub-icon to which the start point corresponds and the sub-icon to which the end point corresponds are located in a column of the splicing screen icon, the sub-layout includes all the sub-icons from the sub-icon 1 to the sub-icon 13 in the column, namely including the sub-icon 1, the sub-icon 5, the sub-icon 9 and the sub-icon 13, and meanwhile, the selected sub-icons 1, 5, 9 and 13 are presented to be in the selected state.

For another example, the start point corresponds to the sub-icon 1, the end point corresponds to the sub-icon 11, that is, the sub-icon to which the start point corresponds and the sub-icon to which the end point corresponds are located in different rows and different columns of the splicing screen icon respectively, so the sub-layout includes all the sub-icons in a rectangular figure with a diagonal line being from the sub-icon 1 to which the start point corresponds to the sub-icon 11 to which the end point corresponds, namely, including the sub-icon 1, the sub-icon 2, the sub-icon 3, the sub-icon 5, the sub-icon 6, the sub-icon 7, the sub-icon 9, the sub-icon 10 and the sub-icon 11, and meanwhile, the selected sub-icons 1-3, 5-7 and 9-11 are presented to be in the selected state.

In other words, the sub-layout includes all the sub-icons covered by a rectangle formed from the start point to the end point.

It should be noted that in some embodiments, only one sub-icon may be selected as the sub-layout, for example, the sub-icon 1 is selected as the sub-layout, “start point” is selected first, then the sub-icon 1 is clicked and set to be the start point, “end point” is selected, then the sub-icon 1 is clicked and set to be the end point, and setting of making the sub-icon 1 serve as the sub-layout is completed in response to selecting “generating a sub-layout” by the user.

Considering that there may be a case of missed selection or a case of non-rectangular layout during setting of the user, in an optional embodiment, after the start point and the end point are selected in the splicing screen icon of the graphical user interface respectively in response to the first operation and the second operation of the user, and the sub-layout is presented according to the start point and the end point, and before the sub-layout is determined in response to the third operation of the user, the video display method may further include: the sub-icons beyond the sub-layout continue to be selected in response to the first operation of the user.

In some embodiments, as for the case of missed selection, supplemental selection is performed by selecting “start point” and clicking the sub-icon, for example, after the user selects the sub-icon 1 as the start point and the sub-icon 3 as the end point, the user also intends to set the sub-icon 4 in the current sub-layout, so the sub-icon 4 is clicked after the ‘start point’ is selected and the sub-icon 4 is presented to be in the selected state, that is, the sub-icon 4 is set as one sub-icon in the current sub-layout besides the selected sub-icons 1-3, and then “generating a sub-layout” is selected, so that the sub-layout includes the sub-icons 1-4. For another example, after the user selects the sub-icon 1 as the start point and the sub-icon 3 as the end point, the user also intends to set the sub-icons 5, 6 and 9 in the current sub-layout to form a triangle, then after “start point” is selected, the sub-icons 5, 6 and 9 are clicked respectively and are presented to be in the selected state besides the selected sub-icons 1-3, and then “generating a sub-layout” is selected, so the current sub-layout is a triangular layout including the sub-icons 1-3, 5-6 and 9.

In order to make operations of the user more convenient, in an optional embodiment, after the start point and the end point are selected in the splicing screen icon of the graphical user interface respectively in response to the first operation and the second operation of the user, and the sub-layout is presented according to the start point and the end point, and before the sub-layout is determined in response to the third operation of the user, the video display method may further include: the start point and the end point are selected in the splicing screen icon of the graphical user interface respectively in response to the first operation and the second operation of the user so as to continue to select the sub-icons beyond the sub-layout.

In some embodiments, as for the cases of missed selection or selection omission, supplemental selection may continue to be performed by selecting “start point” and “end point”, for example, after the user selects the sub-icon 1 as the start point and the sub-icon 3 as the end point, the user also intends to set the sub-icons 5-7 in the current sub-layout besides the sub-icons 1-3, then after “start point” is selected, the sub-icon 5 is clicked, after “end point” is selected, the sub-icon 7 is clicked, thus the sub-icons 5-7 become part of the sub-layout and are presented to be in the selected state, that is, the sub-icons 5-7 are set in the current sub-layout, and then “generating a sub-layout” is selected, so the current sub-layout includes the sub-icons 1-3 and 5-7.

Considering that the user may make a selection mistake, in some embodiments, as shown in FIG. 2A, the video display method may further include: a sub-icon is selected to cancel its configuration in the sub-layout in response to a sixth operation of the user.

In some embodiments, as for the case of selection mistake of the user, the sub-icon selected by mistake is clicked by selecting “cancel” so that the sub-icon can be canceled from the current sub-layout. For example, after the user selects the sub-icon 1 as the start point and the sub-icon 4 as the end point, the user intends to cancel the sub-icon 4 from the current sub-layout, the sub-icon 4 is clicked after “cancel” is selected, thus the sub-icon 4 is presented to be in an unselected state from the selected state, the end point of the current sub-layout is the sub-icon 3, and then “generating a sub-layout” is selected, so the current sub-layout includes only the sub-icons 1-3.

It should be noted that in order to avoid a case of repeated selection during selection of the user, when a sub-icon is set in a sub-layout, the sub-icon cannot be set in other sub-layouts, and the sub-icon can be reset and arranged again only after the sub-icon is canceled from the current sub-layout to which it belongs.

In order to further simplify operations on the graphical user interface, in another specific example, as shown in FIG. 2B, press keys such as “start point”, “end point” and “cancel” are no longer arranged, and selection of the sub-layout is realized only by clicking operations.

In some embodiments, “start point” and “end point” operations are defined as clicking or double clicking a mouse, for example, the sub-icon 1 is selected by double clicking, which means that the sub-icon 1 is the start point, then the sub-icon 7 is double clicked, which means that the sub-icon 7 is the end point, the sub-icons 1-3 and 5-7 are presented in the selected state, that is, the current sub-layout includes the sub-icons 1-3 and 5-7. Meanwhile, in view of an irregular sub-layout or a supplemental selection operation, on the basis of the sub-icons 1-3 and 5-7 being already selected, the supplemental selection is performed in an operation mode different from selecting “start point” and “end point”, for example, the sub-icon 4 is selected so that the sub-icon 4 can be presented in the selected state, then the sub-icon 8 is selected so that the sub-icon 8 can be presented in the selected state, and thus the sub-icons 1-8 are the selected sub-icons in the current sub-layout. For another example, on the basis of the sub-icons 1-3 and 5-7 being already selected, the sub-icons in the rectangular shape continue to be selected for make-up in an operation mode of selecting “start point” and “end point”, In some embodiments, the sub-icon 9 is double clicked, and then the sub-icon 11 is double clicked, so the sub-icons 9-11 are presented in the selected state, and the sub-icons 1-3, 5-7 and 9-11 are the sub-icons contained in the current sub-layout.

In some embodiments, in a view of the cases of redundant selection and selection mistake, on the basis of the sub-icons 1-3, 5-7 and 9-11 included in the current sub-layout being presented to be in the selected state, again clicking is defined as a “cancel” operation, for example, the sub-icons 1, 5 and 9 are clicked, and the sub-icons 1, 5 and 9 are presented to be in the unselected state, so the current sub-layout includes the sub-icons 2, 3, 6, 7, 10 and 11.

As for the case of selecting only one sub-icon as one sub-layout, setting may be made in the above mode, for example, the sub-layout includes only the sub-icon 5, specifically, the sub-icon 5 is double clicked firstly, which means that the sub-icon 5 is set as the start point, then the sub-icon 5 is double clicked, which means that the sub-icon 5 is set as the end point, and at the moment, the sub-icon 5 changes from the unselected state to the selected state.

It should be noted that the present disclosure does not make a specific limit on how to perform the operations on the graphical user interface so as to realize a selected function or cancellation function, those skilled in the art should choose a proper mode according to actual application demands, for example, click definition, double-click definition, or an operation combined with a keyboard, an operation of right click, etc., and make realizing of the selection function be a design criterion, which falls within the protection scope of the present disclosure and will not be repeated in detail herein.

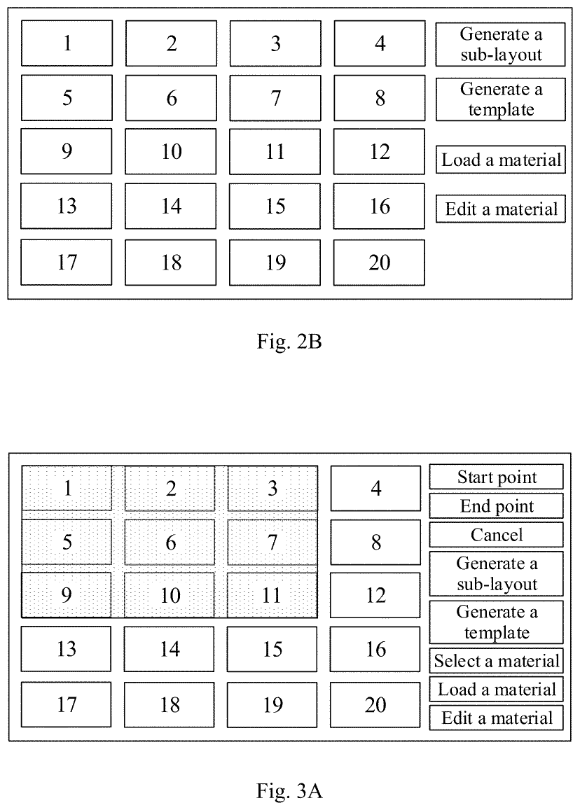

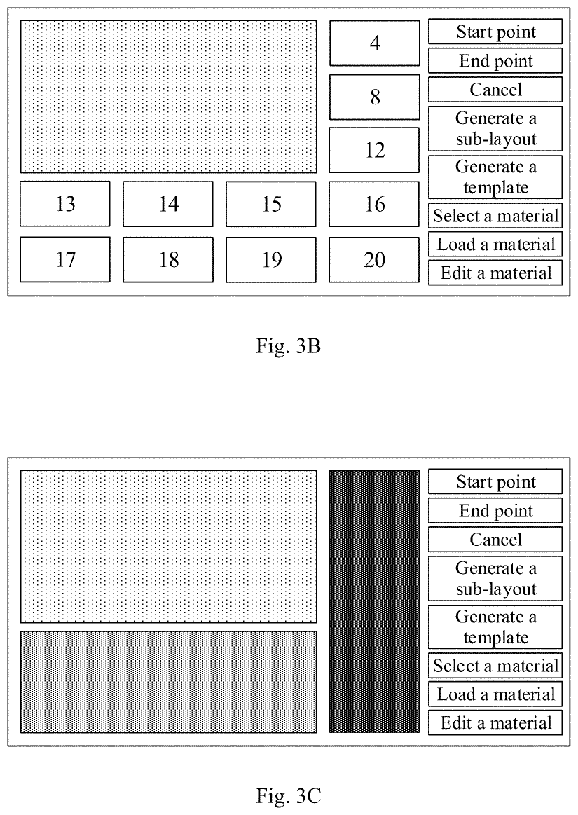

In some embodiments, after the sub-icons contained in the sub-layout are selected, as shown in FIG. 3A, the sub-layout is determined by selecting “generating a sub-layout”, and all the sub-icons of the sub-layout are presented in the selected state.

In view of conveniently recognizing the generated sub-layout, in an optional embodiment, as shown in FIG. 3B, when the start point and the end point are selected in the splicing screen icon of the graphical user interface respectively in response to the first operation and the second operation of the user, and the sub-layout is presented according to the start point and the end point, it may include: all the sub-icons in the sub-layout are combined so as to form a sub-layout icon and present it in a single color.

In some embodiments, after “generating a sub-layout” is selected, all the sub-icons included in the sub-layout are combined to form the integrated sub-layout icon, and the sub-layout icon is presented in one color, for example, presented in red, for conveniently distinguishing and recognizing by the user.

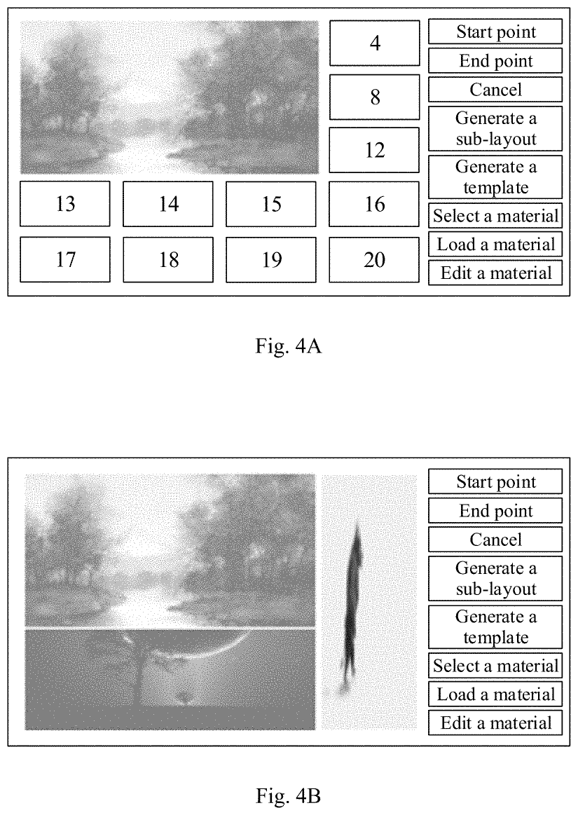

After the sub-layout is generated, as shown in FIG. 4A, “generating a template” is selected so that the set sub-layout can form the video display template and the video display can be presented on the graphical user interface, the video display template is configured to save setting of the sub-layout, and thus the existing sub-layout can be called at any time through the video display template for convenient operation of the user. The video display is presented on the graphical user interface, for example, a video is displayed on the sub-layout according to the video display template by using a default display material so that the user can conveniently know and confirm an actual display condition of the splicing screen on the graphical user interface, then a situation that the actual display condition can be confirmed only when a display material is loaded onto the splicing screen after setting is completed in the related art is avoided, and user experience is effectively improved.

In order to realize actual display of the splicing screen, in some embodiments, the video display method may further include: a to-be-displayed display material is selected in response to a fifth operation of the user and loaded onto the splicing screen according to the video display template.

In some embodiments, a material file list is presented in response to selecting “selecting a material” of the user, the display material selected by the user is loaded onto the splicing screen according to the video display template so that the video display of the splicing screen can be realized. In some embodiments, according to a selected material file and the sub-layout on the video display template, material cutting and processing are performed on the material file through a server or a cloud server so as to respectively form display contents of all the sub-screens suitable for the splicing screen and transmit the contents to all the sub-screens to be configured to be displayed. The video display method of the splicing screen provided by the present embodiment can conveniently and fast perform layout setting on the splicing screen and load the material file so as to realize the video display of the splicing screen, is convenient to operate, improves layout setting efficiency of an existing splicing screen and has wide application prospects.

In view of a case of setting the sub-layout of each of the sub-screens of the whole splicing screen, in some embodiments, after the sub-layout is determined in response to the third operation of the user, the method may further include: sub-layout configuration is performed on all the sub-icons in a splicing screen table.

In some embodiments, setting of the sub-layout is repeated on the graphical user interface by using the above mentioned operations till sub-layout configuration of all the sub-icons is completed, and the video display template is formed through “generating a template.”

Further considering that the user can conveniently distinguish and recognize each of the sub-layouts, in some embodiments, as shown in FIG. 3C, the different sub-layouts form different sub-layout icons, and all the sub-layout icons are presented in different colors.

In some embodiments, the sub-icons contained in each of the different sub-layouts are combined to generate the sub-layout icon, each sub-layout icon is represented in one color, for example, a first sub-layout icon is formed by the sub-icons 1-3, 5-7 and 9-11 and presented in pink, a second sub-layout icon is formed by the sub-icons 13-15 and 17-19 and presented in red, a third sub-layout icon is formed by the sub-icons 4, 8, 12, 16 and 20 and presented in black, and thus recognition and distinguishing are convenient.

In some embodiments, in view of a case of setting the plurality of sub-layouts on the graphical user interface, the different sub-layouts are presented in different colors for convenient recognition and setting of the user. For example, in the above cases of selection omission, missed selection, irregular shape layout and selection mistake, the sub-layouts are distinguished by using the different colors so as to effectively avoid the case of selection mistake. In some embodiments, when the selection omission, the missed selection or the irregular shape layout occurs, a make-up sub-icon is clicked so that a color of the sub-icon can be presented to be in a color of a current sub-layout from an unselected default color. Likewise, when the case of selection mistake occurs, the sub-icon clicked after “cancel” is selected changes from the color of the current sub-layout to the unselected default color, thus, the user can be effectively prompted that the selection of the sub-icon is already canceled, recognizability of each of the operated sub-icons can be greatly improved, the layout setting efficiency of the splicing screen is improved, and user experience is improved.

As shown in FIG. 4B, a preview is made for each of the set sub-layouts by using the selected material on the graphical user interface so that the user can know and confirm the actual display condition of the splicing screen and the user experience can be effectively improved.

It should be noted that the present disclosure does not make a specific limit on setting of the sub-layouts, setting of each sub-layout with part of sub-icons, and setting of each sub-layout with all the sub-icons, and meanwhile also does not make a specific limit on a sequence of setting of each of the sub-layouts. Those skilled in the art should select a sequence of all the steps according to actual demands, for example, when the plurality of sub-layouts are arranged, each of the sub-layouts can be set respectively, then the video display template is generated, and the display condition of the certain sub-layout can be previewed on the graphical user interface, or setting of all the needed sub-layouts is completed, then the video display template is generated, and the display conditions of all the needed sub-layouts are previewed on the graphical user interface, which will not be repeated in detail herein.

In order to make the operations of the user more convenient, in an optional embodiment, as shown in FIG. 2A and FIG. 2B, the video display method may further include: a preset image material is loaded onto the graphical user interface in response to a seventh operation of the user, and the display material is generated. The image material includes at least one element arranged in a cascading mode, and the element includes a picture and a text.

In some embodiments, in order to enable the user to conveniently select and edit a video displayed on the splicing screen, the image material may be directly loaded in response to an operation of the user, and the image material is processed to generate the display material, including:

an image material list is presented in response to selecting “loading a material” by the user, and the selected image material is loaded onto the graphical user interface according to selection of the user.

In some embodiments, the image material list includes a plurality of image materials, each of the image materials corresponds to at least one to-be-displayed video, picture or text, for example, may be a comprehensive material including the video, the picture and the text or include only the picture or the text, the selected image material is loaded onto the graphical user interface and divided into a plurality of elements, each of the elements is one of the video, the picture or the text, and all the elements in each of the image material are mapped onto the graphical user interface for convenient operation and editing.

In some embodiments, after the preset image material is loaded onto the graphical user interface in response to the seventh operation of the user, and the display material is generated, the method may further include: a cascading style sheet is loaded onto the graphical user interface in response to an eighth operation of the user, and motional configuration is performed on each of the elements of the image material respectively so as to generate the display material.

In some embodiments, the cascading style sheet is loaded in response to selecting “editing a material” by the user, and motional configuration is performed on each of the elements of the image material respectively so as to generate the display material.

In some embodiments, cascading style sheets 3 (CCS3) are integrated on the graphical user interface and are configured to be a computer language expressing an HTML or an XML and other document styles, the CSS3 can set the elements in the image material so that the elements can realize some simple motional effects in a certain period, and the to-be-displayed image material can become more streamlined and smoother. For example, motional attributes of the CSS3 can perform motional configuration on the text element or the picture element, the text element or the picture element is set to be a more complex style change or generate an interaction effect without any Flash or JavaScript script code. In some embodiments, the motional configuration includes performing at least one of a displacement operation, a rotation operation, a scaling operation and a color configuration operation on each of the elements respectively. The displacement operation, the rotation operation, the scaling operation and the color configuration operation correspond to different display effects respectively, which can be used independently or jointly or use different operation sequences during jointing to generate different motional effects.

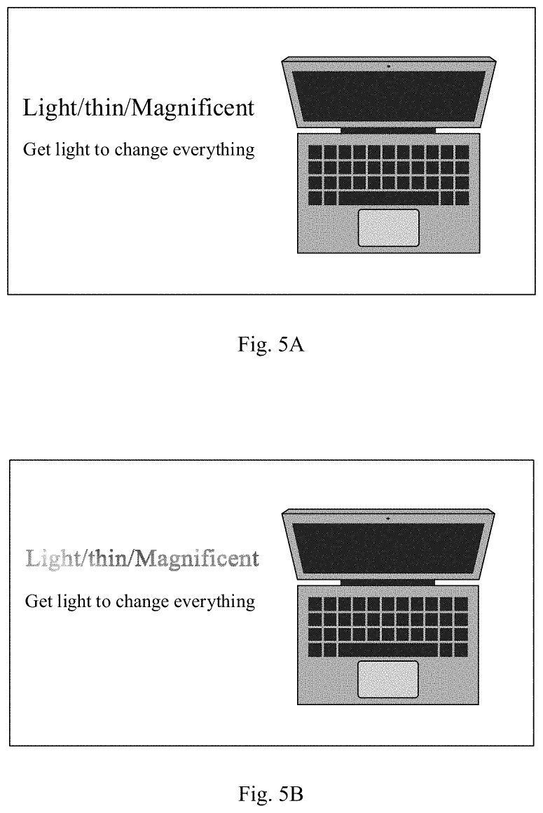

In some embodiments, as shown in FIG. 5A and FIG. 5B, FIG. 5A is an image material, including the text element and the picture element, FIG. 5B is a display element generated by setting the motional effects on the text element and the picture element, the CSS3 performs the color configuration operation on the text element, cycling high-light dynamic display of the text is presented by setting different gradients at different percentages of the text, and the CSS3 performs the displacement operation and the scaling operation on the image element so as to present a dynamic display of the picture, so that flexibility and effectiveness of the display material are effectively improved.

In some embodiments, specific steps are as follows.

First step, the graphical user interface performs flex layout and element positioning on the text element and the picture element in the image material by using tools such as the integrated front-end htm15, CSS and JS, for example, the text element or the picture element in the image material is scaled in percentage on the premise of ensuring that there is no distortion of the image material according to a size of the displaying splicing screen, for example, a landscape mode or a portrait mode.

Second step, the graphical user interface performs motional configuration on the text element or the picture element in the image material by using the integrated CSS3, for example, a motional response is realized through keyframes and transform, all the elements are moved to different spaces through a displacement function (translate), proportions of all the elements are increased or decreased through a scaling function (scale), all the elements are rotated by different display angles through a rotational function (rotate), all the elements are skewed through a skew function (skew), and the text element is set by using the unique attributes of the CSS3 such as linear-gradient, text-fill-color and background-clip so as to realize color change and high-light display of the text in different time.

Third step, all the elements positioned in the first step are combined with the motional attributes set in the second step, so that motional uniqueness of all the elements is realized, and the display material with a dynamic display effect is generated.

Fourth step, a plurality of edited and generated display materials are saved, for example, saved in a user computer, the server or the cloud server, etc. for subsequent on-line or off-line use.

It should be noted that the video display template set and generated by the user in the above steps may also be saved in the user computer, the server or the cloud server, etc. For example, a plurality of different video display templates are manufactured according to the different display materials, and the different video display templates are selected when the display materials are replaced, which is not limited by the present disclosure. The related technical solutions of the various video display templates and display materials based on embodiments fall within the protection scope of the present disclosure.

In some embodiments, the CSS3 is loaded into the graphical user interface, the to-be-displayed image material can be edited at a Web front end so as to generate the display material so that each of the elements of the to-be-displayed image material can be dynamically videoed and will not be limited to simple motionless content display in the related art, thereby realizing the video display of each of the elements from motionless to motional. Meanwhile, the dynamic display materials are loaded onto the splicing screen through the video display templates, so that displaying of the dynamic display materials is realized by using the splicing screen, and display efficiency of the splicing screen is effectively improved. Besides, the display materials can be conveniently and fast replaced through the graphical user interface, and the user experience is effectively improved.

It should be noted that the present disclosure does not make a sequence limit on the steps of setting the video display template and editing the image material, those skilled in the art can select to firstly arrange the video display template and then edit the image material according to the arranged template, or firstly edit the image material and then set the video display template according to the edited image material according to the actual application demands, so that the video display of the splicing screen is the design criterion, which is not repeated in detail herein.

Likewise, the present disclosure does not make a limit on the various operations on the graphical user interface, those skilled in the art can set the various operations according to operation demands and operation habits, for example, adding an operation of the landscape mode or the portrait mode of the splicing screen, or reducing the operation of editing the materials, and the like, so that setting of the video display templates of the splicing screens and editing of the image materials are the design criterion, which is not repeated in detail herein.

Based on the same inventive concept, corresponding to the video display method of the splicing screen provided by embodiments, some embodiments of the present disclosure further provides a video display apparatus of a splicing screen based on a graphical user interface. As the video display apparatus provided by embodiments of the present disclosure corresponds to the video display method, the above implementations are also suitable for the video display apparatus, which will not be described in detail in the present embodiment.

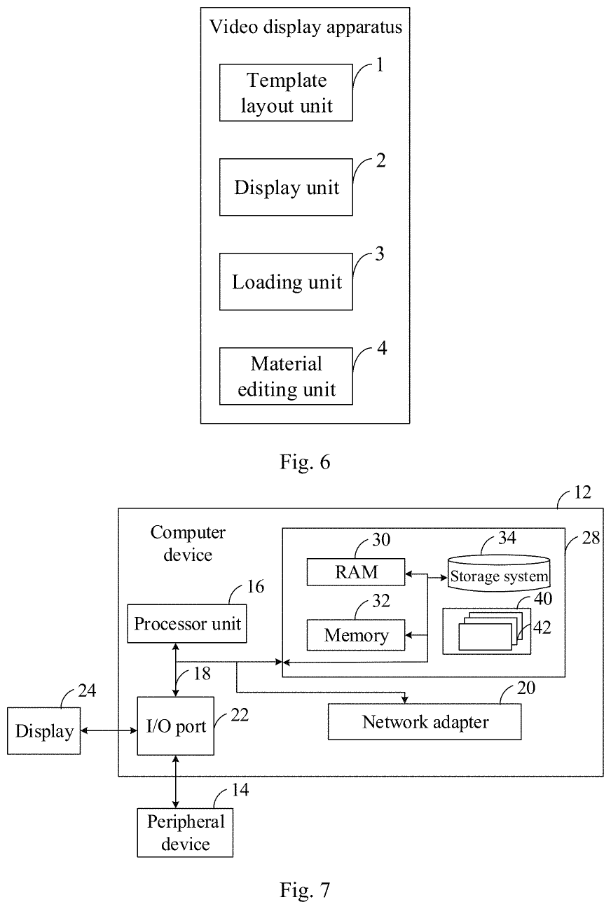

As shown in FIG. 6, the video display apparatus of the splicing screen based on the graphical user interface provided by embodiments of the present disclosure, includes a template layout unit and a display unit.

The template layout unit 1 is configured to configure a splicing screen icon displayed on the graphical user interface to be at least one sub-layout including a start point and an end point, and generate a video display template according to each configured sub-layout, wherein the splicing screen icon includes a plurality of sub-icons, each of the sub-icons is an object respectively mapping a sub-screen in the splicing screen onto the graphical user interface, and the sub-layout comprises all sub-icons covered from the start point to the end point.

A display unit 2 is configured to present a video display on the graphical user interface according to the video display template.

In some embodiments, each sub-screen of the splicing screen is mapped into the sub-icon on the graphical user interface, layout setting of each sub-screen of the splicing screen is realized through operations of the template layout unit on the graphical user interface so as to generate the video display template, and a video preview is presented on the graphical user interface through the display unit according to the set video display template, so that convenient and fast setting and real-time displaying of the splicing screen are realized, display setting efficiency of each sub-screen of the splicing screen is effectively improved, and application prospects are wide.

In some embodiments, the video display apparatus may further include a loading unit 3, configured to load a to-be-displayed display material onto the video display template to present it on the splicing screen.

In some embodiments, the selected display material is loaded onto the splicing screen through the loading unit 3 according to the video display template, so that the video display of the splicing screen is conveniently and fast realized.

In some embodiments, the video display apparatus may further include a material editing unit 4, configured to load a preset image material and a cascading style sheet, and perform motional configuration on each element in the image material through the cascading style sheet so as to generate the display material.

In some embodiments, the image material is edited through the cascading style sheet integrated with the graphical user interface to generate the display material capable of being loaded onto the splicing screen and with a motional effect so that the video display of the splicing screen can be conveniently and fast realized.

The apparatus embodiment described in FIG. 6 is only exemplary, for example, partitioning of the above units is only a logical function partition, there may be other partitioning modes during actual realizing, for example, a plurality of modules or components can be combined or integrated into another system, or some features may be omitted, or not executed. All function units in all the embodiments of the present application can be integrated in one processing module, or all units are physically independent, or two or more units are integrated in one module. All the units in the above apparatus can be realized in a form of hardware or a form of a software function unit. For example, when the software is adopted, the above template layout unit, the display unit and the loading unit, etc. may be realized by generating a software function module after at least one processor reads a program code stored in a memory, or respectively realized by different hardware in a computer (a display apparatus), for example, some of the template layout unit, the display unit and the loading unit, etc. are realized by part of processing resources (for example, one or two cores in a multi-core processor) in at least one processor, and the rest of the template layout unit, the display unit and the loading unit, etc. are realized by the rest of processing resources (for example, other cores in the multi-core processor) in the at least one processor.

Based on the same inventive concept, another embodiment of the present disclosure further provides a computer readable storage medium with a computer program stored thereon. When the program is executed by a processor, it is realized: a start point and an end point are selected in a splicing screen icon of a graphical user interface respectively in response to a first operation and a second operation of a user, and a sub-layout is presented according to the start point and the end point, wherein the splicing screen icon includes a plurality of sub-icons, each of the sub-icons is an object respectively mapping a sub-screen in the splicing screen onto the graphical user interface, and the sub-layout includes all the covered sub-icons from the start point to the end point; the sub-layout is determined in response to a third operation of the user, whether there is the sub-icons not configured in the sub-layout in the splicing screen icon is judged, if yes, selection of the start point and the end point is repeated so as to configure the sub-layout till layout configuration of all the sub-icons in the splicing screen icon is completed; and the video display template is generated in response to a fourth operation of the user, and a video display template of the splicing screen is generated, and a video display is presented on the graphical user interface according to the video display template.

During actual application, the computer readable storage medium may be any combination of one or more computer readable media. The computer readable medium may be a computer readable signal medium or a computer readable storage medium. The computer readable storage medium may be but is not limited to, for example, an electrical, magnetic, optical, electromagnetic, infrared, or semi-conductor system, apparatus or device, or any combination of the above. More specific examples (not an exhaustive list) of the computer readable storage medium include: an electrically connected and portable computer disk, hard disk, random access memory (RAM), read-only memory (ROM), an erasable programmable read-only memory (EPROM or a flash memory), an optical fiber, a portable compact disk read-only memory (CD-ROM), an optical storage device, a magnetic storage device with one or more conducting wires, or any suitable combination of the above. In the present embodiment, the computer readable storage medium may be any tangible medium including or storing a program. The program may be used by an instruction executing system, apparatus or device or used jointly by them.

The computer readable signal medium may include a data signal in a baseband or propagated as part of a carrier wave, which bears a computer readable program code. The propagated data signal may be of various forms, including but not limited to an electromagnetic signal, an optical signal or any suitable combination of the above. The computer readable signal medium may be any computer readable medium beside the computer readable storage medium. The computer readable medium can send, propagate or transmit a program configured to be used by the instruction executing system, apparatus or device or used jointly by them.

The program code contained in the computer readable medium can be transmitted by using any suitable medium, including but not limited to a wireless, an electrical wire, an optical cable, RF, etc., or any suitable combination of the above.

The computer program code for executing operations of the present disclosure can be compiled with one or more programming language or their combination. The programming language includes a programming design language oriented to an object, such as Java, Smalltalk, C++, and further includes a conventional procedural programming language, such as “C” language or similar programming languages. The program code may be executed completely on a user computer, or executed partially on the user computer, or executed as a stand-along software package, or executed partially on the user computer and partially on a remote computer, or executed completely on the remote computer or a server. In a case of involving the remote computer, the remote computer may be connected to the user computer through any type of networks, including a local area network (LAN) or a wide area network (WAN), or may be connected to an external computer (for example, providing an Internet connection through an Internet service provider).

As shown in FIG. 7, which is a schematic structural diagram of a computer device provided by another embodiment of the present disclosure. The computer device 12 shown in FIG. 7 is only an example and is not supposed to bring any limit to functions and an application range of embodiments of the present disclosure.

As shown in FIG. 7, the computer device 12 is represented in a form of a general-purpose computer device. Components of the computer device 12 may include but are not limited to: one or more processors or a processor unit 16, a graphical user interface, a system memory 28, and a bus 18 connected with different system components (including the system memory 28 and the processor unit 16).

The bus 18 represents one or more of several bus structures and includes a memory bus or a memory controller, a peripheral bus, a graphics acceleration port, a processor or a local bus of any bus structure among various bus structures. For example, these system structures include but are not limited to an industry standard architecture (ISA) bus, a micro-channel architecture (MAC) bus, an enhanced ISA bus, a video electronics standards association (VESA) local bus and a peripheral component interconnect (PCI) bus.

The computer device 12 typically includes various computer system readable media. These media may be any applicable medium into which the computer device 12 can access, including a volatile and non-volatile medium, and a removable or non-removable medium.

The system memory 28 may include a computer system readable medium in a form of a volatile memory, for example, the random access memory (RAM) 30 and/or a cache memory 32. The computer device 12 may further include other removable/non-removable, volatile/non-volatile computer system storage media. Only for example, a storage system 34 may be used for reading and writing a non-removable and non-volatile magnetic medium (not shown in FIG. 7, generally called “hard disk drive”). Though it is not shown in FIG. 7, the hard disk drive used for reading and writing a removable non-volatile magnetic disk (for example, “floppy disc”), and an optical disk drive for reading and writing a removable non-volatile optical disk (for example, the CD-ROM, DVD-ROM or other optical media) can be provided. In these cases, each drive can be connected with the bus 18 through one or more data medium ports. The system memory 28 may include at least one program product, the program product has one group of (for example, at least one) program module, and these program modules are configured to execute functions of all the embodiments of the present disclosure.

A program/utility tool 40 with one group of (the at least one) program module 42 may be stored, for example, in the system memory 28, the program module 42 include but is not limited to an operating system, one or more application programs, other program modules and program data, each of or a certain combination of these examples may include executing of a network environment. The program module 42 usually executes functions and/or the method in the described embodiments of the present disclosure.

The computer device 12 may also communicate with one or more peripheral devices 14 (for example, a keyboard, a pointing device, and a display 24), or communicate with one or more devices capable of making a user interact with the computer device 12, and/or communicate with any device (for example, a network card, a modem, etc.) capable of making the computer device 12 communicate with one or more other computer devices. The communication may be performed through an input/output (I/O) port 22. Besides, the computer device 12 may communicate with one or more networks (for example, the local area network (LAN), a wide area network (WAN) and/or a public network, for example, Internet) through a network adapter 20. As shown in FIG. 7, the network adapter 20 communicates with other modules of the computer device 12 through the bus 18. It should be understood that though it is not shown in FIG. 7, with reference to other hardware and/or software modules used by the computer device 12, it may include but it not limited to: a microcode, a device drive, a redundant processing unit, a peripheral disk drive array, an RAID system, a magnetic tape drive, a data backup storage system, etc.

The processor unit 16 executes various function applications and data processing by making the program stored in the system memory 28 run, for example, the video display method of the splicing screen provided by embodiments of the present disclosure is realized.

Specific to the existing problems at present, the present disclosure designs the video display method and video display apparatus of the splicing screen, the computer device and the medium, each sub-screen of the splicing screen is mapped onto the sub-icon of the graphical user interface, the video display template is generated by layout setting of the sub-icons on the graphical user interface, and the video display of the splicing screen is completed by using the video display template so that the problems in the related art can be solved, convenient and fast operation and easy updating can be realized, the layout setting efficiency of the splicing screen is effectively improved, and the application prospects are wide.

It needs to be noted that the sequence of the steps of the video display method provided by embodiments of the present disclosure can be properly adjusted, the steps can also be added or deleted correspondingly according to the conditions, and any person knowing the technical field well falls within the protection scope of the present disclosure within the technical scope disclosed in the present disclosure, which will not be repeated in detail herein.

Apparently, the above embodiments of the present disclosure are only examples for clearly setting forth the present disclosure rather than intend to limit the implementations of the present disclosure, those ordinarily skilled in the art may further make other changes or modifications of different forms on the basis of the above description, all implementations cannot be listed exhaustively herein, and all obvious changes or modifications extended from the technical solutions of the present disclosure still fall within the protection scope of the present disclosure.

1. A video display method of a splicing screen, comprising:
selecting a start point and an end point in a splicing screen icon of a graphical user interface respectively in response to a first operation and a second operation of a user, and presenting a sub-layout according to the start point and the end point, wherein the splicing screen icon comprises a plurality of sub-icons, each of the sub-icons is an object respectively mapping a sub-screen in the splicing screen onto the graphical user interface, and the sub-layout comprises all sub-icons covered from the start point to the end point;
determining the sub-layout in response to a third operation of the user; and
generating a video display template in response to a fourth operation of the user and presenting a video display on the graphical user interface.

2. The video display method according to claim 1, further comprising:
selecting, in response to a fifth operation of the user, a to-be-displayed display material and loading the to-be-displayed display material onto the splicing screen according to the video display template.

3. The video display method according to claim 1, wherein the selecting the start point and the end point in the splicing screen icon of the graphical user interface respectively in response to the first operation and the second operation of the user, and presenting the sub-layout according to the start point and the end point, comprises:
combining the sub-icons in the sub-layout to form a sub-layout icon and presenting the sub-layout icon in a single color.

4. The video display method according to claim 3, wherein after the determining the sub-layout in response to the third operation of the user, further comprising:
performing a sub-layout configuration on the sub-icons in the splicing screen icon.

5. The video display method according to claim 4, wherein different sub-layouts form different sub-layout icons, and the sub-layout icons are presented in different colors.

6. The video display method according to claim 1, wherein the sub-icon to which the start point corresponds and the sub-icon to which the end point corresponds form a rectangular region.

7. The video display method according to claim 6, wherein the rectangular region comprises:
in response to a sub-icon to which the start point corresponds and a sub-icon to which the end point corresponds being located in a row of the splicing screen icon, the sub-layout comprises sub-icons from the start point to the end point in the row;
in response to a sub-icon to which the start point corresponds and a sub-icon to which the end point corresponds being located in a column of the splicing screen icon, the sub-layout comprises sub-icons from the start point to the end point in the column; and
in response to a sub-icon to which the start point corresponds and a sub-icon to which the end point corresponds being located in different rows and different columns of the splicing screen icon respectively, the sub-layout comprises the sub-icons in a rectangle with a diagonal line being from the sub-icon to which the start point corresponds to the sub-icon to which the end point corresponds.

8. The video display method according to claim 1, wherein after selecting the start point and the end point in the splicing screen icon of the graphical user interface respectively in response to the first operation and the second operation of the user, and presenting the sub-layout according to the start point and the end point, and before determining the sub-layout in response to the third operation of the user, the method further comprising:
continuing to select sub-icons beyond the sub-layout in response to the first operation of the user; and
selecting the start point and the end point in the splicing screen icon of the graphical user interface respectively in response to the first operation and the second operation of the user so as to continue to select the sub-icons beyond the sub-layout.

9. The video display method according to claim 1, further comprising:
in response to a sixth operation of the user, selecting a sub-icon in the sub-layout so as to cancel configuration of the sub-icon in the sub-layout.

10. The video display method according to any of claim 1, further comprising:
in response to a seventh operation of the user, loading a preset image material onto the graphical user interface and generating a display material, wherein the image material comprises at least one element arranged in a cascading mode, and the element is one of a video, a picture or a text.

11. The video display method according to claim 10, wherein after loading the preset image material onto the graphical user interface and generating the display material, the method further comprising:
in response to an eighth operation of the user, loading a cascading style sheet onto the graphical user interface to perform a motional configuration on each element of the image material respectively so as to generate the display material.

12. The video display method according to claim 11, wherein the motional configuration comprises at least one of a displacement operation, a rotation operation, a scaling operation or a color configuration operation for each element respectively.

13. (canceled)

14. A computer readable storage medium with a computer program stored thereon, wherein in response to the program being executed by a processor, the method according to claim 1 is implemented.

15. A computer device, comprising a graphical user interface, a memory, a processor and a computer program stored on the memory and capable of running on the processor, wherein the processor is configured to execute the program to implement the method according to claim 1.
